(19) United States
(12) Patent Application Publication
(10) Pub. No.: US 2007/0229778 A1
(43) Pub. Date: Oct. 4, 2007

(54) Time-multiplexed 3D display system with seamless multiple projection

(76) Inventors: Soohyun Cha, Woodland Hills, CA (US); Adrian Travis, Cambridge (GB); Neil Dodgson, Cambridge (GB)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/392,330

(22) Filed: Mar. 28, 2006

(51) Int. Cl. G03B 21/26

(52) U.S. Cl. 353/94

(57) ABSTRACT

An image processing method eliminates the seams between adjacent projectors in a multi-projector autostereoscopic display system. The abutting views of two adjacent projectors are overlapped. The image generator shows the same image in the overlapped views, so that the viewer cannot see the seam.

### BACKGROUND OF THE INVENTION

1. Field of the Invention

This invention relates generally to the field of video display systems. More particularly, the invention relates to a multi-projector autostereoscopic system for presenting a three dimensional display in which the seams between adjacent projectors are effectively eliminated.

2. Background

Time multiplexing technology for achieving a three dimensional display is described in U.S. Pat. No. 5,132,839. The system disclosed therein comprises an image projector or “backlighting” apparatus for projecting beams of light in selected directions, a spatial light modulator or shutter for displaying images back lit by the backlighting apparatus and a control system coupled to both the spatial light modulator and the backlighting apparatus. The control system causes a plurality of images of an object to be formed in succession on the spatial light modulator with each image being a view of the subject form a different angle, and each image being viewable only from particular angles. The images are formed one at a time on the spatial light modulator with a plurality of images constituting a single frame of a video picture. In the described embodiments, the backlighting apparatus includes a two dimensional display device for emitting spots of lights at selected locations along the two dimensional display, and a lens system for refracting light emitted by the two dimensional display device. The lens system refracts beams emanating from a spot of light on the two dimensional display into substantially parallel rays. The different individual views of the subject are thus projected onto an image plane at discrete horizontal positions, referred to as eye boxes or view ports, the positions being spaced apart by a distance that is less than the intra-pupillary spacing of a human. An observer is thus presented with a stereoscopic view of the subject. Furthermore, a sufficient number of different views are provided so that the observer may move from side to side to “see” the subject from different angles.

The number of different view angles in such an autostereoscopic display system is limited by practical considerations, including the image refresh rate of the image projector and the size of the shutter. Thus, the horizontal field of view is necessarily limited. One straightforward way to increase the field of view is utilize multiple projectors. However, the seams between projectors are noticeable due to the difficulty of abutting the view planes side by side. In this case, as a viewer moves his or her head horizontally, either black seam lines are noticeable or superimposed images are noticed. There was an attempt to reduce the visual effect of the seams by placing an optical diffuser in the projection path. This method reduced, but did not eliminate, the visual effect of seamlines. However, the overall image quality is reduced due to the lenticular lens used as a diffuser.

### SUMMARY OF THE INVENTION

The present invention provides an image processing method that eliminates the seams between adjacent projectors in a multi-projector autostereoscopic display system. The abutting views of two adjacent projectors are overlapped. The image generator shows the same image in the overlapped views, so that the viewer cannot see the seam. However, using this method, one field of view is lost.

### BRIEF DESCRIPTION OF THE DRAWINGS

FIG. 1 is a schematic diagram of a prior art autostereoscopic display system with multiple projectors.

FIG. 2 is a schematic diagram illustrating the seam line between abutting views of adjacent projectors in the system of FIG. 1.

FIG. 3 is a schematic diagram of a 3D display system in accordance with one embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

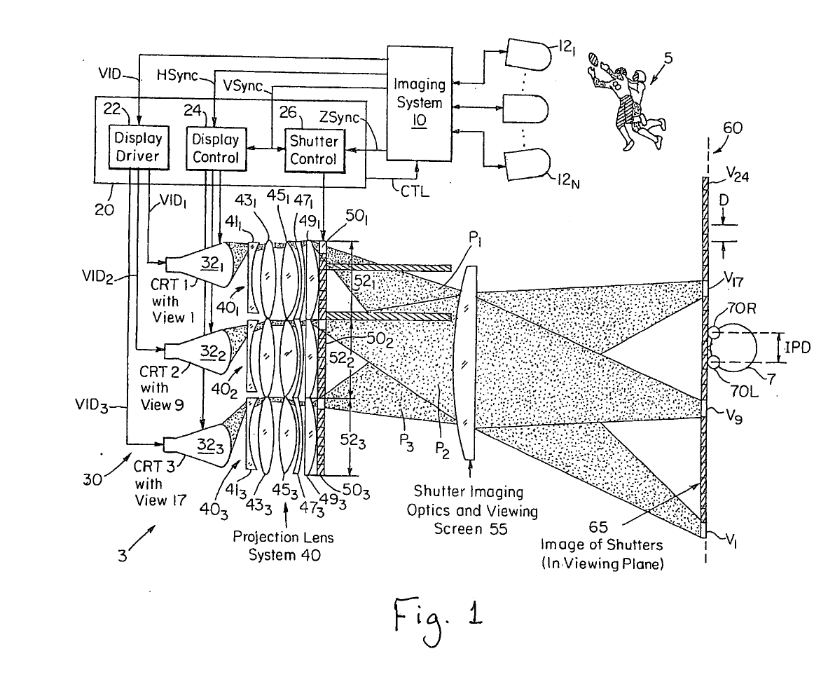

FIG. 1 is a schematic diagram of a prior art multi-projector autostereoscopic system as disclosed in U.S. Pat. No. 6,481,849. Views of an object 5 are captured by an array of still or video cameras 12₁, 12₂, . . . , 12_{N}. An imaging system 10 prepares the captured images for display. The images and video synchronization signals are provided to a control system 20 over a video bus VID and synchronization connections HSync, VSync, ZSync. The control system 20 can control operation of the cameras 12₁, . . . , 12_{N} via a control bus CTL to the imaging system 10. Alternatively, the views may be computer generated and stored by the imaging system 10.

The control system 20 provides video signals to an imaging system 30. The imaging system 30 comprises an array of image sources 32₁, 32₂, 32₃, which can be cathode ray tube (CRT) or liquid crystal display devices. Although only three CRTs are illustrated, any number of CRTs can be used, with certain optical constraints, depending on the total number of discrete views desired. The image sources 32 also receive control signals from the control system 20.

A projection lens system 40 is optically coupled to the imaging system 30. In particular, the projection system 40 includes a plurality of projection subsystems 40₁, 40₂, 40₃, which are each coupled to a respective image source 32₁, 32₂, 32₃. Each projection lens subsystem 40 includes a plurality of projection lenses 41, 43, 45, 47, 49. The exit pupils 52₁, 52₂, 52₃ of the image sources 32₁, 32₂, 32₃ are defined by the front projection lenses 49₁, 49₂, 49₃. As illustrated, the front projection lenses 49₂ directly abut adjacent front projection lenses 49₁, 49₃.

Light from the exit pupils 52₁, 52₂, 52₃ is processed by respective shutter elements 50₁, 50₂, 50₃. The shutter elements 50 are spatial light modulators, each of which includes a moveable slit controlled by the control system 20. The shutter elements 50 may be liquid crystal devices and the slit may be a vertical light modulating cell which can be selected from about 5-8 vertically arranged positions in each shutter element 50. Alternatively, the light-modulating cell can be selected from a plurality of two-dimensionally arranged windows in each shutter element.

Although the shutter elements 50₁, 50₂, 50₃ are shown to be forward of the exit pupils 52₁, 52₂, 52₃, that arrangement is not required. Indeed, the shutter elements 50₁, 50₂, 50₃ can be positioned behind the front projection lenses 49₁, 49₂, 49₃. Preferably, the shutter elements 50₁, 50₂, 50₃ are positioned as close as possible to the exit pupils 52₁, 52₂, 52₃. The further the shutter elements are positioned forward of the exit pupils, more optical efficiency is lost.

In operation, the control system 20 controls the image sources 32 and the respective shutter element 50 such that a different video frame is provided on the displays for each slit position in the shutter element. In particular, the video frames are time-multiplexed in step with the shutters. In that way, a plurality of pupils is created for each image source 32.

As shown, a plurality of video signals VID₁, VID₂, VID₃ is provided by a display driver 22 of the control system 20 to respective image sources 32₁, 32₂, 32₃. In addition, horizontal synchronization (HSync), vertical synchronization (VSync), and video field synchronization (ZSync) signals are processed by the control system 20. In particular, a display control module 24 receives the HSync and VSync signals to drive the image sources 32. A shutter control module 26 receives the VSync and ZSync signals and drives the shutter elements 50. The VSync signal is used to synchronize the video frames of the image sources 32 with the slits in the shutter elements 50.

Although not shown, a separate red, green, blue (RGB) filter element can be placed over each image source 32. These color filter elements may be used to sequentially create a color video frame from a broad spectrum image generator. The display control module 24 would then operate the color filter elements.

For a particular frame of an image source 32, the projection system 40 projects an image projection P₁, . . . , P₉, . . . , P₁₇, . . . , P₂₄ to a common viewing optic 55, which may be a Fresnel lens. The viewing optic 55 focuses each exit pupil onto a virtual exit pupil or viewing port V₁, . . . , V₂₄ on an imaging plane 60. These viewing ports provide a view of the frame image on the image source.

At any one time, the viewing optic 55 provides the views from the selected pupil of each image source 32 to a viewing space 65 for viewing by an observer 7 or a plurality of observers. Each observer 7 typically maintains the left eye 70L and the right eye 70R in the viewing space. The eyes are spaced apart by an intra-pupillary distance (IPD). As shown, there is a plurality of viewing ports V₁, . . . , V₂₄ at the imaging plane 60, each providing a view of a respective video frame of a respective image source. The optics are optimized so the views of the slits at the viewing space 65 abut each adjacent view and are spaced apart by a distance D on center. To minimize the perception of seams, so that the images appear continuous as the viewer's head moves, the distance D is preferably less than or equal to one-half the IPD. Typically, the slits are between 22-25 mm wide at the observer's eye. Each eye 70L, 70R thus sees a different image source 32 to create an illusion of three-dimensional objects.

The field lens 55, which is generally a Fresnel lens equal in size to the effective screen dimensions, has no effect on the real image of the CRT. Its function is to create a real image of the directing shutter at the optimum viewing plane for the observer. Thus the Fresnel lens determines the size of the region where an observer can see a full-screen 3-D image. For practical systems, the depth of the viewing region may extend several feet beyond the optimum viewing plane. A folded optical system having a concave mirror for the viewing optic 55 may be utilized. The concave mirror operates as a viewing screen, focusing the light onto the respective viewing ports. By employing mirrors, the optical path can be folded to increase the focal length of the system while maintaining a relatively compact size.

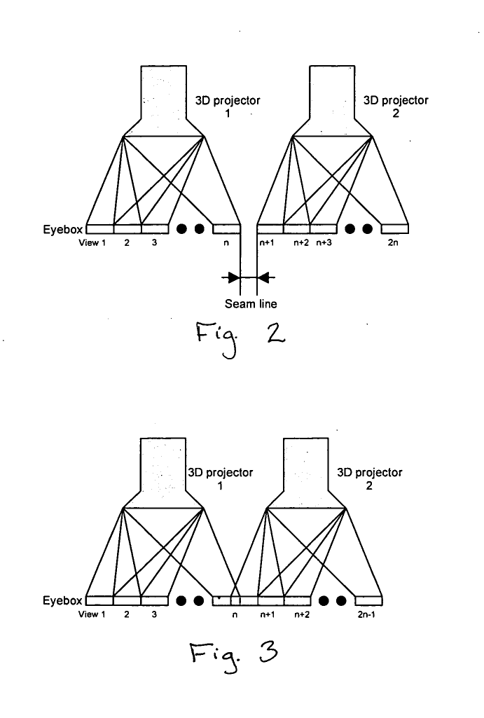

It would be desirable to have the exit pupils of the projection lens systems abut without any gap; however, there are practical constraints that prevent this from being accomplished. Therefore, there is an unavoidable seam between the views of adjacent projectors as illustrated in FIG. 2. View n from projector 1 cannot directly abut view n+1 from projector 2, so a black seam is perceived between the two views. If the views were to be overlapped, the viewer would see the overlapped images at that viewing position.

In the prior art system discussed above, it has been suggested to use a lenticular lens to lengthen the exit pupil unidirectionally and horizontally. A lenticular lens is a flat sheet, usually acrylic plastic, having a series of lines, each being in effect a very narrow cylindrical lens with semicircular profile. A typical lenticular lens may have 50 to 100 lines per inch and functions as a unidirectional diffuser. Such lenses are commonly used as the front screen on a large-screen projection television where the lines are mounted vertically so as to widen laterally the angle of view for the screen. As long as the image from the projection lens system 40 creates a real image on the lenticular lens, the image itself is not diffused by the lens, only the exit pupil. A similar effect is seen when viewing objects through a regular diffuser, such as a piece of frosted glass. Objects far from the glass are completely fogged when viewed through it, but a hand pushed up against the glass is clearly visible on the other side.

As with a projection television system, a lenticular lens can be positioned to produce horizontal stretching and so merge the viewing ports for the multiple projector system. However, this would destroy the 3D effect by merging together the different camera views. A goal is to provide a very small amount of horizontal smearing; enough to remove the seams and soften the edges of the various views, but not enough to destroy the 3D effect. If the seams are initially minimized by carefully abutting the projector lens systems as close as possible, then typically a unidirectional diffuser with about one tenth of a degree of angular spread is needed. Practical lenticular lenses are made out of acrylic plastic with a refractive index of 1.491 and produce between 20 and 40 degrees of angular diffusion. It may be possible to produce an acrylic lenticular lens with considerably less angular diffusion, but the tooling needed to produce a lens of that particular design would be very expensive. It is therefore difficult to employ the prior art approach to achieve a satisfactory balance between seam removal and clear 3D imagery.

FIG. 3 illustrates the solution afforded by the present invention. The abutting views from adjacent projectors are overlapped, but each of the overlapped views presents the same image n. This effectively eliminates the seam between adjacent projectors at the cost of one view per projector pair. Thus, for the two projectors shown, the number of views is reduced from 2n to 2n−1. The repeated views do not need to be overlapped completely, because, unlike the overlapping of images on a screen, there are no registration issues. It is the viewing ports that are overlapped, not the real images. Thus, less than complete overlapping would simply give the viewer a slightly larger window to image n. In the overlapping region, users perceive twice the brightness. This effect can be eliminated by placing against the liquid crystal shutter a filter of varying opacity. The filter should be fully transparent everywhere except in front of one or both of the peripheral segments. Here, the opacity of the slit should vary smoothly from fully transparent on one side of the segment to fully opaque on the other. That way, there will be none of the variations in brightness which are so apparent to the human eye.

The method of the present invention may be readily implemented, for example, with appropriate modifications to the operation of control system 20 in the prior art display system discussed above. Such modifications are well within the capabilities of persons of ordinary skill in the field of autostereoscopic display systems and thus will not be further discussed herein.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. In a 3D display system having at least first and second image projectors, a method of eliminating seam lines between adjacent projectors comprising:
projecting images 1, . . . , n from the first image projector;
projecting images n, n+1, . . . , 2n−1 from the second image projector;
aligning the first and second image projectors such that image n projected by the first image projector substantially overlaps image n projected by the second image projector.

2. An apparatus for displaying a three-dimensional view of an object, comprising:
a plurality of image sources displaying a plurality of sequential images in a time-multiplexed manner;
a plurality of spatial light modulators, each spatial light modulator comprising a plurality of light modulating cells and coupled to a respective image source; and
a control unit coupled to each image source and each spatial light modulator, the control unit operating the light modulating cells in sequence with the sequential images;
wherein the control unit operates adjacent image sources and respective adjacent spatial light modulators to project the sequential images as a plurality of contiguously arranged discrete views in a viewing space and to overlap adjoining views of the adjacent image sources.

3. The apparatus of claim 2 wherein the overlapped adjoining views contain the same image.
